(19) United States
(12) Patent Application Publication
(10) Pub. No.: US 2008/0095396 A1
(43) Pub. Date: Apr. 24, 2008

(54) User Interface for Contraband Detection System

(75) Inventors: Kristoph D. Krug, Sudbury, MA (US); John Oliver Tortora, Westford, MA (US); Richard Franklin Eilbert, Lincoln, MA (US); Shunghe Shi, Southborough, MA (US)

Correspondence Address: WOLF GREENFIELD & SACKS, P.C., 600 ATLANTIC AVENUE, BOSTON, MA, 02210-2206, US

(73) Assignee: L-3 Communications Sercurity and Detection Systems Inc.

(21) Appl. No.: 11/667,036

(22) PCT Filed: Nov. 3, 2005
(86) PCT No.: PCT/US05/39826

§ 371 Date: Nov. 16, 2007

Related U.S. Application Data
(60) Provisional application No. 60/624,589, filed on Nov. 3, 2004.

(51) Int. Cl. G06K 9/00

(52) U.S. Cl. 382/100

(57) ABSTRACT

An improved user interface for use with systems that display images. The interface allows easy control over the appearance of images. The user interface allows motion of a single input device to control at least two parameters of an image mapping. The controls impact the appearance of the image in real time. An operator may use the interface to optimize the appearance of a region of the image. The invention is described in connection with a contraband detection system that includes a touch screen input device. Images formed by the inspection systems are mapped to a display, with parameters provided through the touch screen controlling the mapping. The interface is employed to control the contrast of the image displayed for the operator. The value of one parameter obtained through the interface controls an intensity level at which the contrast mapping is nonlinear. The value of the second parameter obtained through the interface controls the amount of the nonlinearity.

### BACKGROUND OF INVENTION

1. Field of Invention

This invention relates generally to inspection systems and more specifically to user interfaces to inspection systems.

2. Discussion of Related Art

Inspection systems are widely used to detect contraband concealed in items. For example, inspection systems are used at airports to identify explosives, weapons or other contraband in luggage or other parcels. Inspection systems are also used in connection with the inspection of cargo or in other settings.

FIG. 1 illustrates an inspection system 100, such as exists in the art. Items to be inspected are placed on a moving conveyor 102 that passes the items through a tunnel 104. Within the tunnel, an image of the item under inspection is formed. Many inspection systems use penetrating radiation, such as x-rays, to form the image. In this way, objects within an item under inspection may appear in the image.

The image formed by inspection system 100 may be presented directly to a human operator. Alternatively, the image may be analyzed or further processed by a computer, with the results of computerized processing being presented to a human operator.

FIG. 1 shows an operator station 110. Operator station 110 includes a display screen 112 on which an operator may view images of items within the inspection system 100. Operator station 110 also includes an input device 114 through which the operator may provide inputs to control either inspection system 100 or the appearance of display 112.

### SUMMARY OF INVENTION

The invention relates to an improved user interface for a system that displays images.

In one aspect the invention relates to an inspection system of a type having a human operator. The system comprises a display adapted to present an image to the operator. The system includes an operator interface having at least one input device adapted to be manipulated by the operator, the input device outputting at least two parameters that vary in response to manipulation of the at least one input device. A computer processor coupled to the operator interface and the display is adapted to generate the image. The image has at least two visual properties that vary in response to the at least two parameters.

In another aspect, the invention relates to a method of operating an inspection system. The method comprises acquiring data concerning an item under inspection and displaying an image of the item under inspection using the data. User input representing at least two parameters is received through an operator interface and at least two attributes of the displayed image are varied in response to the at least two parameters.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a prior art inspection system;

FIG. 2 is a sketch of a portion of a user interface according to an embodiment of the invention;

FIGS. 3A and 3B are graphs useful in understanding contrast enhancement;

FIG. 4A is a sketch of an image of a suitcase;

FIG. 4B is an image of the suitcase in FIG. 4A shown with greater contrast; and

FIGS. 5A-5I are graphs useful in understanding operation of the user interface of FIG. 2.

### DETAILED DESCRIPTION

It would be desirable to have an improved user interface that is easy to use and allows an operator to more rapidly and accurately inspect items for suspicious objects. As described herein, such an improved user interface includes an input device through which the operator enters values of a plurality of parameters. In some embodiments, the values control parameters of an image mapping and can be used to increase the contrast of objects in an image presented to the operator. Some embodiments include a touch sensitive surface through which at least two independent parameters associated with an operator input may be detected and applied to the image being displayed in real time.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

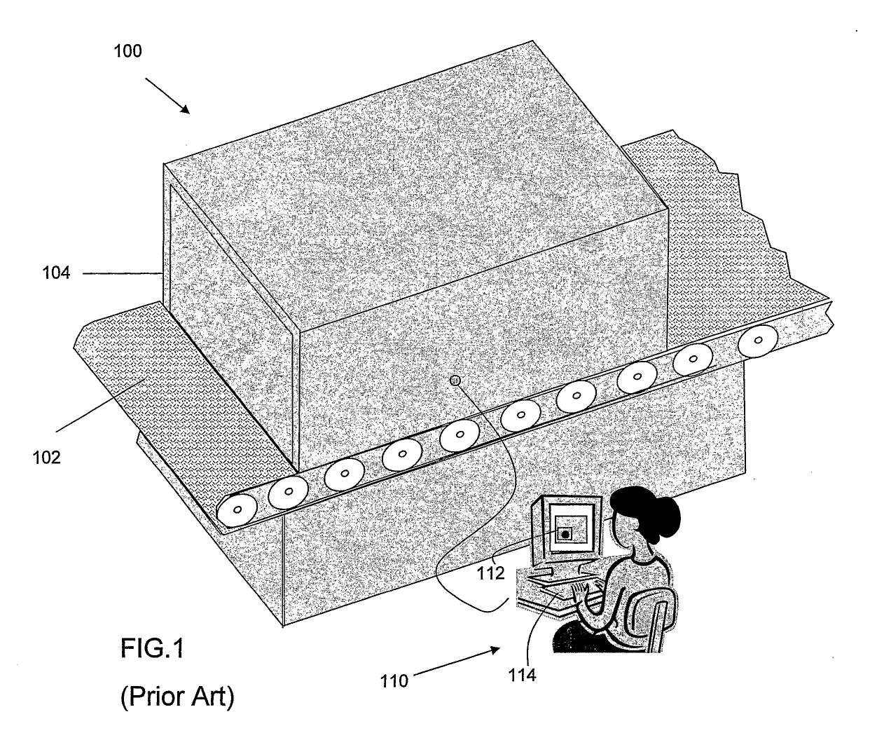

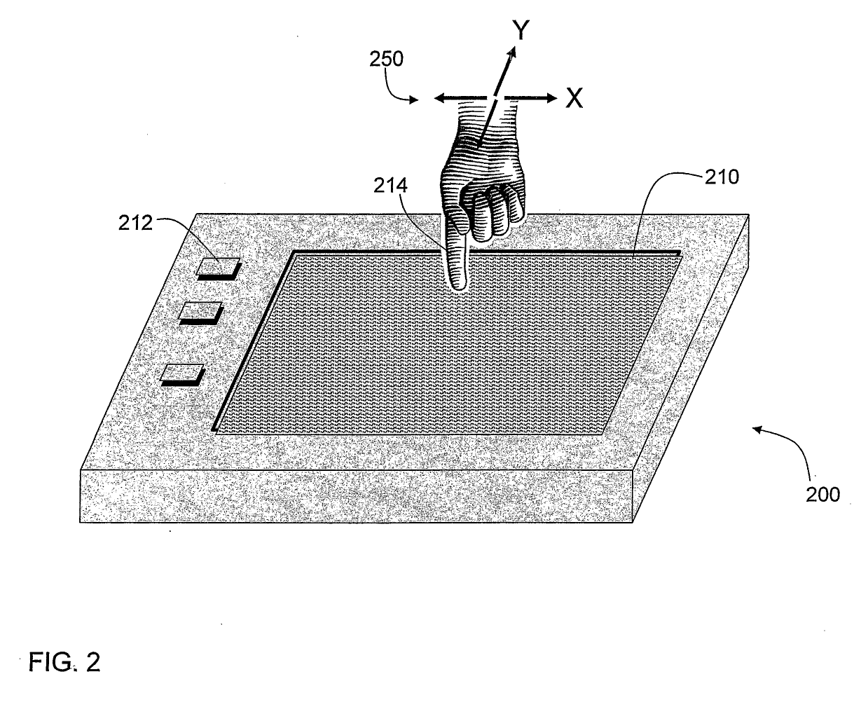

FIG. 2 shows a user input device 200 that may be used in connection with an operator interface such as 114 shown in FIG. 1. In the illustrated embodiment, user input device 200 includes a touch sensitive surface, which is here illustrated as touch screen 210. However, other touch sensitive devices are known in the art. For example, touch pads are known.

User input device 200 may include one or more controls 212. Controls 212 may be buttons, switches or other controls that an operator can use instead of or in addition to touch screen 210 to provide input. Controls 212 may, for example, control the function of touch screen 210. Controls 212 may be physical devices such as switches or buttons. Alternatively, controls 212 may be implemented as menu functions that appear on touch screen 210. In use a user provides input through touch screen 210 by moving a finger 214 over the surface of touch screen 210. Touch screen 210 produces an output that identifies the position of finger 214 on the surface of touch screen 210. A computer processor coupled to touch screen 210 may use this output to determine the value of a parameter.

For example, in the prior art, touch screen 210 provided an output indicating the position at which finger 214 made contact with touch screen 210. The output indicated the position of the finger in a XY coordinate system, as indicated by legend 250. In the prior art inspection system, the X component of the output of touch screen 210 was used as a parameter to control the contrast of the image displayed on the operator interface such as screen 112 (FIG. 1). In these prior art systems, the Y value of the position output by touch screen 210 was not used while the screen was being used to obtain a contrast parameter.

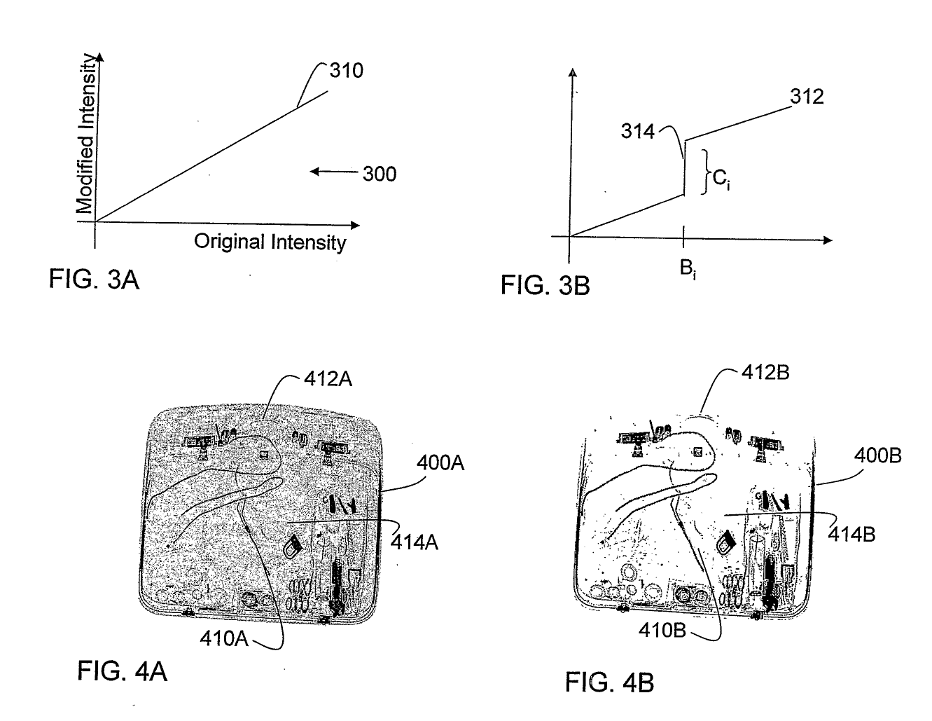

FIGS. 3A and 3B illustrate how a parameter controlling contrast may be used to impact the image displayed at the operator interface station 110. The inspection system 100 produces an image of an item under inspection. The image is represented by an array of pixel values. Each pixel value has an intensity associated with it. A computer processor controlling display 112 maps pixel values from the image created by inspection system 100 to pixel values controlling specific locations on the display 112. FIG. 3A is an example of a mapping 300 in which there is a linear relationship between the original intensity of the image produced by inspection system 100 and the modified image displayed on screen 112.

FIG. 3B shows a modified mapping between original intensity and modified intensity used to form the image displayed on screen 112. FIG. 3B shows a nonlinear relationship represented by the line 312 that includes a portion 314. In this example, the portion 314 is a step of magnitude Cᵢ occurring at an intensity level indicated as Bᵢ. When an image formed by inspection system 100 is displayed using the mapping of FIG. 3B, pixels in the original image having an intensity slightly higher than Bᵢ will appear significantly lighter than pixels having an intensity slightly less than Bᵢ in the original image. In this way, objects in the original image with an intensity of slightly more than Bᵢ will stand out against a background with an intensity that is less than Bᵢ, i.e. their contrast is enhanced. The amount by which the contrast is enhanced for such pixels is determined by the magnitude of the parameter Cᵢ.

Contrast enhancement is illustrated in connection with FIG. 4A and FIG. 4B. FIG. 4A uses as an example an image of a suitcase 400A. Image 400A reveals objects inside the suitcase as well as details of the suitcase. For example, a wire 410A is visible in the image. A handle 412A is also visible in the image.

FIG. 4B shows a modified image 400B formed from image 400A. In image 400B, the contrast has been enhanced. In FIG. 4B, wire 410B is accentuated in comparison to the background 414B. Contrast enhancement makes wire 410B more visible, making the image in FIG. 4B potentially more useful for an operator making an assessment of whether wire 410B represents a contraband item.

However, enhancing the contrast as illustrated in FIG. 4B also removes some detail from the image. For example, handle 412B is less visible than handle 412A. The pixels representing handle 412A generally have intensity values that are greater than Bᵢ. When those pixels are re-mapped using the mapping of FIG. 3B, the intensity of those pixels is increased. Though the intensity of pixels representing the background is also increased, the result of the re-mapping is that the absolute difference in intensity between pixels representing the handle and pixels representing the background is decreased and the handle is less visible relative to the background.

Different contrast settings may be appropriate for an image depending on the features being examined. Within an image, different contrast settings may be appropriate at different times to facilitate examination of different parts of the image. To highlight important some features, but to avoid obscuring other relevant details, it is desirable to allow an operator to control the contrast when mapping an image produced by inspection system 100 to an image displayed for a human user such as 112. In this way, the user can control the contrast enhancement to make objects of interest more visible.

According to one embodiment of the invention, an operator may control the amount of contrast adjustment, Cᵢ as well as the intensity, Bᵢ, at which the contrast adjustment occurs. Values for each of these parameters may be derived simultaneously from an input device.

In the embodiment illustrated, user input device 200 may receive input from the operator specifying both parameters. As described above, user input device 200 can determine two coordinates of an object touching touch screen 210. As shown in FIG. 2, touch screen 210 is sensitive to the X and Y position of an object touching touch screen 210. In the illustrated embodiment, the X position controls the amount of contrast enhancement and the Y position controls the intensity at which this contrast enhancement is applied. However, any suitable convention may be used to relate an input obtained through a user input device to control parameters.

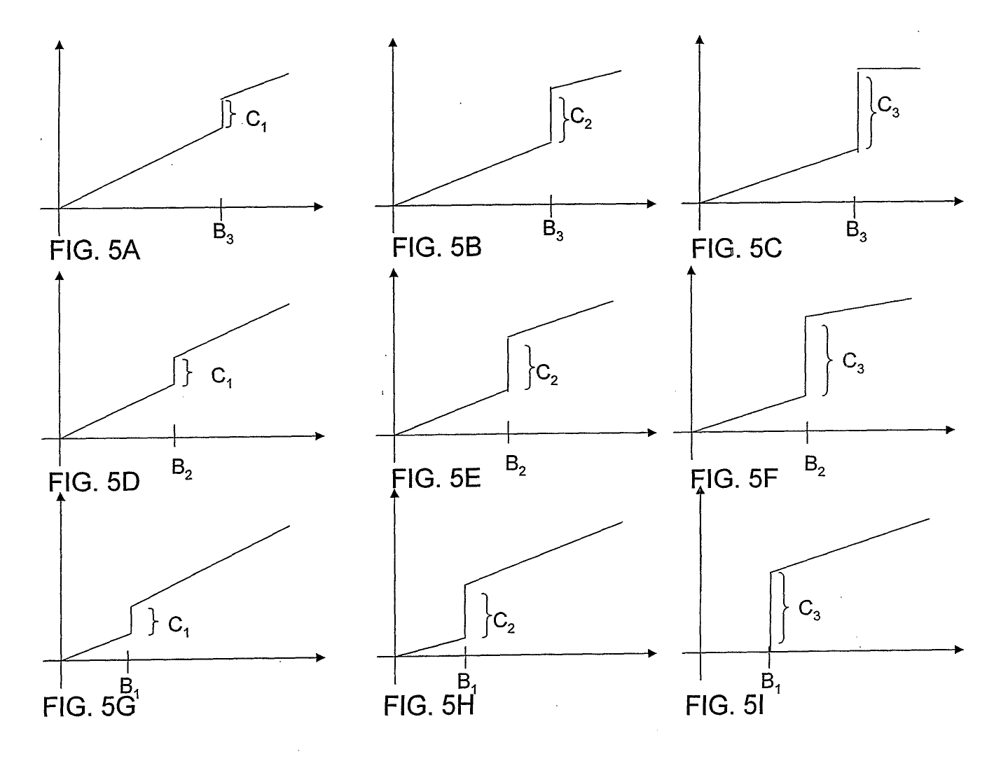

FIGS. 5A-5I show a series of mappings of intensity levels from an initial image formed by an inspection system to the intensities used in a display for a human operator. The specific mapping used depends on the X and Y position of finger 214 on touch screen 210.

FIGS. 5D, 5E and 5F represent mappings with the same Y value, but an increasing X value. Accordingly, C₂ as shown in FIG. 5B is larger than C₁ shown in FIG. 5A. C₃ shown in FIG. 5C is larger than C₂ shown in FIG. 5B. FIGS. 5C, 5D and 5E represent mappings made with the same X values as FIGS. 5A, 5B and 5C, respectively. Accordingly, they show the same pattern of increasing contrast enhancement amounts as FIGS. 5A, 5B and 5C. FIGS. 5D, 5E and 5F have the a smaller Y value than FIGS. 5A, 5B and 5C. As a result, the intensity B₂ at which the contrast enhancement is applied is lower than intensity B₃ illustrated in FIGS. 5A, 5B and 5C.

FIGS. 5G, 5H and 5I similarly represent mappings made with the same X values as FIGS. 5A, 5B and 5C, respectively. Accordingly, they show the same pattern of increasing contrast enhancement amounts as FIGS. 5A, 5B and 5C. But, FIGS. 5G, 5H and 5I reflect an even smaller Y value than FIGS. 5D, 5E and 5F. As a result, the intensity B₁ at which the contrast enhancement is applied in FIGS. 5G, 5H and 5I is lower than intensity B₂ illustrated in FIGS. 5D, 5E and 5F.

FIGS. 5A . . . 5I illustrate that a human operator may adjust both the amount of contrast enhancement and the intensity at which this contrast enhancement is applied by moving a finger or other object across the touch screen 210. In use, an operator may display an image of an object on a display screen such as 112. The operator may examine the image while holding a finger over touch screen 210. By moving the finger in the X and Y directions, the operator may selectively increase the contrast of certain portions of the image by controllable amounts. In this way, the operator may alter the contrast settings to enhance the appearance of objects in the image that are of interest to the operator.

In one embodiment, the parameters provided through the operator interface are applied to the image in real time. Real time, in this context, means that the operator can observe the change in the image while using the input device. The operator does not need to operate other controls to apply settings before seeing the effect of the re-mapping on display 112.

In one embodiment, a display such as display 112 (FIG. 1) includes a video memory. A video display driver uses the information in the video memory to control the appearance of the pixels on the display 112. The screen display is continuously refreshed with data in the video memory. A mapping function, such as those depicted in FIGS. 5A . . . 5I is continuously applied to the information loaded into the video memory. Any change in the parameters defining the mapping function is, after no more than a relatively short delay, reflected in the values loaded into the video memory so that it will visible on the display 112. The amount of the delay will depend on factors such as the size of the video display and the operating speed of the hardware implementing the system. Preferably, the delay is less than 0.1 seconds.

In one contemplated application, the operator examines images created with an inspection system that creates x-ray images of items under inspection. The operator examines the images to detect contraband. As the operator observes suspicious regions, the operator may then selectively enhance the contrast of those regions. For example, the operator may move his finger in the X direction, as illustrated in FIG. 2. The operator may move his finger to set the intensity Bᵢ (FIG. 3B) to a level slightly below the intensity of objects in the area of interest.

The operator may then move his finger in the Y direction to change the amount Cᵢ (FIG. 3B) of contrast adjustment until the item under inspection appears in a format that is easy to examine. If the amount of contrast enhancement is too little, the objects of interest in the image may not appear significantly different than their surroundings. If the amount of contrast enhancement is too much, too much information may be lost from the image. Because the image is continuously variable in response to the input, the operator can observe the image getting better or worse for examination of a specific region of the image.

By changing the display in real time in response to the user input, the operator has greater ability to optimize the settings. When the setting is close to the desired setting, the operator may “dither” his finger and observe which direction causes the area of interest in the image to become more easy to examine. The operator may continue in this fashion until he finds a point from which further change does not improve the image.

Having a user interface that allows values of two parameters to be input simultaneously also allows the operator to move his finger with a motion that combines both X and Y motion simultaneously. Thus, the operator may simultaneously optimize the image for both parameters, such as by dithering his finger in an orientation that is 45 degrees to both the X and Y directions. Other motions may also be used to optimize the display. For example, the operator may move his finger in a circular motion to find values of parameters that create a display that is readily analyzed.

If an item under inspection has multiple suspicious regions, the operator may set the appearance of the image that is suitable for examining one suspicious region. The operator may then change the parameters for suitable viewing of other suspicious regions.

Having thus described several aspects of at least one embodiment of this invention, it is to be appreciated various alterations, modifications, and improvements will readily occur to those skilled in the art.

For example, a touch screen is described as a user interface device. While a touch screen provides a useful interface device, any user input device that can detect two or more input parameters may be used. For example a mouse, roller ball, pointing stick, digitizing pad or similar user interface device may be used.

Also, it is not necessary that a “touch sensitive” input device respond directly to pressure. Some touch screens receive operator input by using light beams to sense the position of the operator's finger. When the finger is in the path between a light source and a light detector, the position of the finger may be ascertained. Other suitable technology may also be used to sense the position of the operator's finger. For example, a capacitive sensor may be used to detect the position of the finger.

Also, it was described that the user interface is activated by the operator's finger. Where the user interface is sensitive to pressure or position, any device, including a pencil or similar object, could be used to provide the input. Systems could also be constructed that use sensors to detect a pointing device based on a certain characteristic of that device. For example, a stylus with a magnetic head could be used in conjunction with sensors in the interface device that sense magnetic fields.

Also, the invention is described in connection with a contraband detection system, but it is not so limited. For example, the user interface described above may be used in connection with any system displaying images to a human operator. For example, it may be used in connection with a system to display x-ray images formed for medical diagnostics.

The invention need not be limited to use in connection with specific hardware to generate images. The inspection system may be a transmission based X-ray inspection system that forms an image of a two dimensional projection of an item under inspection. Alternatively, the inspection system could be a computed tomography system that forms images of slices of items under inspection. Further, the invention may be employed in connection with images that depict three dimensional properties of items under inspection.

Further, controls to adjust image properties may be used for any image attributes and may be used in conjunction with images having attributes that are not directly affected by real-time operator controls. For example, the image may be displayed on a color display. Color may be used, for example, to represent material properties of an item under inspection, such as atomic number.

If color is used, the intensity used to display each pixel may depend in part on the color. As described above, the intensity of each pixel on the display is set based on the measured attenuation for a region of the item under inspection corresponding to the pixel and a mapping between attenuation and intensity is used to set the pixel intensity. However, these are not the only factors that may control intensity. In addition, the intensity may be selected, in part, based on the color of the pixel. As is known, different colors of the same intensity appear to a human to be of different brightness. The appearance of brightness is sometimes called luminance. Therefore, a different mapping between measured attenuation and intensity may be used for each pixel based on the color of that pixel to present regions of similar attenuation with the same luminance. Alternatively, mappings such as shown in FIGS. 5A-5I may relate a measured attenuation to a luminance and a second mapping may be made between luminance and intensity, based on the color of the pixel.

Further, controlling image appearance as described above may be used in conjunction with other image enhancement techniques. For example, it may be used in connection with an edge enhancement process.

As a further example of variations, the touch sensitive surface may be part of a display screen, which could display the image or could display other information, such as operator controls or menus.

Such alterations, modifications, and improvements are intended to be part of this disclosure, and are intended to be within the spirit and scope of the invention. Accordingly, the foregoing description and drawings are by way of example only.

1. A contraband detection system of a type having a human operator, comprising:
a) a conveyor for moving a plurality of items through the contraband detection system;
b) a display adapted to present an image of an item under inspection of the plurality of items to the operator;
c) an operator interface having at least one input device adapted to be manipulated by the operator, the input device outputting at least two parameters that vary in response to manipulation of the at least one input device; and
d) a computer processor coupled to the operator interface and the display, the computer processor adapted to generate the image, the image having at least two visual properties that vary in response to the at least two parameters.

2. The contraband detection system of claim 1, wherein the operator interface comprises a touch sensitive surface.

3. The contraband detection system of claim 2, wherein the input device is a touch screen.

4. The contraband detection system of claim 3, wherein the touch screen is adapted to display control information.

5. The contraband detection system of claim 2, wherein the touch sensitive surface extends in a first direction and in a second direction and the at least two parameters comprise a first parameter and a second parameter, the first parameter having a value indicative of where along the first direction the touch sensitive surface is touched, and the second parameter having a value indicative of where along the second direction the touch sensitive surface is touched.

6. The contraband detection system of claim 1, wherein the input device comprises a pointing device.

7. The contraband detection system of claim 6, wherein the pointing device comprises a tablet, mouse or roller ball.

8. The contraband detection system of claim 1, wherein the display is a color display.

9. The contraband detection system of claim 1, wherein the computer processor is adapted to vary the image in real time.

10. A method of operating contraband detection system, the method comprising:
a) acquiring data concerning an item under inspection;
b) displaying an image of the item under inspection using the data by mapping the data to at least two image attributes;
c) simultaneously receiving through an operator interface user input representing at least two parameters while the image is displayed; and
d) varying the mapping between the data and the at least two attributes of the displayed image in response to the at least two parameters.

11. The method of operating contraband detection system of claim 10, wherein receiving user input comprises receiving user input of at least two continuously variable parameters, and varying at least two attributes of the displayed image comprises continuously varying the displayed image.

12. The method of operating contraband detection system of claim 11, wherein the operator interface comprises a touch sensitive surface and receiving user input comprises receiving user input representing a position at which an operator appendage contacts the touch sensitive surface.

13. The method of operating contraband detection system of claim 10, wherein varying at least two displayed attributes of the image comprises varying a contrast and an intensity at which the contrast is applied.

14. The method of operating contraband detection system of claim 10, wherein displaying an image of the item under inspection comprises mapping the acquired data concerning the item under inspection to image characteristics and varying at least two attributes of the displayed image comprises re-mapping the acquired data to image characteristics.

15. The method of operating the contraband detection system of claim 14, wherein mapping the acquired data concerning the item under inspection to image characteristics comprises mapping a measured x-ray attenuation at each of a plurality of locations within the item under inspection to an intensity at a location in the image.

16. The method of operating the contraband detection system of claim 15, wherein re-mapping the acquired data to image characteristics comprises applying a mapping having a discontinuity of a magnitude dictated by a first of the at least two parameters and at an intensity value dictated by a second of the at least two parameters.

17. The method of operating the contraband detection system of claim 14, wherein mapping the acquired data further comprises mapping the acquired data for each of a plurality of locations in the item under inspection to a color at a location in the image based on a measured material property at the location in the item under inspection.

18. The method of operating the contraband detection system of claim 10, wherein displaying an image comprises displaying a color image.

19. The method of operating the contraband detection system of claim 10, wherein displaying an image comprises accentuating edges of objects within the item under inspection.

20. The method of operating the contraband detection system of claim 10, wherein varying at least two attributes of the displayed image in response to the at least two parameters comprises varying the at least two attributes in real time.

21. The method of operating the contraband detection system of claim 10, further comprising:
e) examining a first portion of the image;
f) receiving through the operator interface further user input representing the at least two parameters; and
g) further varying the at least two attributes of the displayed image in response to the at least two parameters representing the further user input; and
h) examining a second portion of the image.
